(19) United States
(12) Patent Application Publication
(10) Pub. No.: US 2017/0332822 A1
(43) Pub. Date: Nov. 23, 2017

(54) FOOD CONTAINER

(71) Applicant: TACO BELL CORP., Irvine, CA (US)

(72) Inventor: Mark Ramos, Irvine, CA (US)

(21) Appl. No.: 15/598,158

(22) Filed: May 17, 2017

Related U.S. Application Data
(60) Provisional application No. 62/338,438, filed on May 18, 2016.

(51) Int. Cl. A47J 27/00; B65D 25/20; B65D 21/02; B65D 25/28; B65D 43/02; B65D 81/34

(52) U.S. Cl. CPC A47J 27/002; B65D 43/0204; B65D 81/3453; B65D 81/3438; B65D 21/0217; B65D 25/28; B65D 25/205; B65D 2525/283

(57) ABSTRACT

Food containers for use in packaging, storing, transporting, cooking, and/or serving food contents are provided. The food container can include a pan defining a receptacle. The pan can include one or more side walls, a base, and a lip. The lip can include a thickness sufficient to support the weight of the pan and food contents. The food container may include a lid disposed over the opening into the pan. The lid can be shaped to receive a base of an adjacent pan.

### CROSS-REFERENCE TO RELATED APPLICATIONS

This application claims the benefit of U.S. Provisional Application No. 62/338,438, filed on May 18, 2016, which is incorporated by reference herein in its entirety.

### BACKGROUND

### Field

This disclosure relates generally to the field of food storage, and more particularly to systems, methods, and devices for storing, transporting, and/or cooking food.

### SUMMARY

According to some embodiments, a disposable food container can include a pan. The pan can be sized and shaped to define a receptacle for holding food. At least a portion of the pan can include polypropylene.

In some embodiments, the pan further comprises a plurality of side walls and a lip extending outwardly from a top end of the plurality of side walls, wherein the lip is sized and shaped to support the pan. In some embodiments, the food container is configured to be heated at a heating temperature of at least 275 degrees Fahrenheit, and the melting temperature of the polypropylene is greater than the heating temperature. In some embodiments, the food container is configured to be heated at a heating temperature of at least 275 degrees Fahrenheit, and the deformation temperature of the polypropylene is greater than the heating temperature.

In some embodiments, the food container includes an engagement feature, wherein the engagement feature limits lateral movement of a second food container disposed above the food container. In some embodiments, the engagement feature includes a lid. The lid can include a recess to receive at least a portion of the second food container. In some embodiments, the food container can be cooled at a cooling temperature of at least 34 degrees Fahrenheit, and the freezing temperature of the polypropylene is less than the cooling temperature. In some embodiments, the plurality of sidewalls are configured to not substantially deform when the temperature of the food container is adjusted.

According to some embodiments, a method of implementing a disposable food container includes storing a food in a disposable food container, heating the pan with the food disposed within the receptacle; and locating the pan into a slot of an assembly line. The food container can include a pan sized and shaped to define a receptacle for holding food. At least a portion of the pan can include polypropylene.

In some embodiments, the pan includes a plurality of side walls and a lip extending outwardly from a top end of the plurality of side walls, and the lip is sized and shaped to support the pan. In some embodiments, the pan includes a bottom surface of the lip of the pan is configured to contact an upper surface of an assembly line, and the lip is sized and shaped to support the pan within the slot of the assembly line.

In some embodiments, heating the pan comprises heating the pan at a heating temperature of at least 275 degrees Fahrenheit, and the melting temperature of the polypropylene is greater than the heating temperature. In some embodiments, the heating the pan comprises heating the pan at a heating temperature of at least 275 degrees Fahrenheit, and the deformation temperature of the polypropylene is greater than the heating temperature. In some embodiments, the food container does not substantially deform when the food container is heated. In some embodiments, the method includes stacking the food container above a second food container, wherein the plurality of side walls is configured to support a the second food container disposed above the pan. In some embodiments, the food container includes an engagement feature, wherein the engagement feature limits lateral movement of the second food container disposed above the food container.

According to some embodiments, a method of storing food includes: storing food in a stackable food container at a first location and stacking the food container on top of a second food container. The food container can include a pan sized and shaped to define a receptacle for holding food. At least a portion of the pan can include polypropylene.

In some embodiments, the pan includes a plurality of side walls and a lip extending outwardly from a top end of the plurality of side walls, and the lip is sized and shaped to support the pan. In some embodiments, a bottom surface of the lip of the pan is configured to contact an upper surface of an assembly line, and the lip is sized and shaped to support the pan within the slot of the assembly line. In some embodiments, the food container is configured to be heated at a heating temperature of at least 275 degrees Fahrenheit, and the melting temperature of the polypropylene is greater than the heating temperature.

### BRIEF DESCRIPTION OF THE DRAWINGS

The foregoing and other features, aspects, and advantages of the embodiments of the invention are described in detail below with reference to the drawings of various embodiments, which are intended to illustrate and not to limit the embodiments of the invention. The drawings comprise the following figures in which:

FIG. 1 illustrates an embodiment of a food container according to a preferred embodiment of the present invention.

FIG. 2 illustrates a side view of the food container from FIG. 1.

FIG. 3 illustrates a plurality of the food containers from FIG. 1 disposed in an assembly line.

FIG. 4A illustrates the food container from FIG. 1 with an embodiment of a cover or lid.

FIG. 4B illustrates the food container from FIG. 1 with another embodiment of a cover or lid.

FIG. 5 illustrates a plurality of the food containers from FIG. 1 disposed in a transport vehicle.

FIG. 6 illustrates an example method of using a food container.

FIG. 7 illustrates an example method of using a food container.

### DETAILED DESCRIPTION

Although several embodiments, examples and illustrations are disclosed below, it will be understood by those of ordinary skill in the art that the invention described herein extends beyond the specifically disclosed embodiments, examples and illustrations and includes other uses of the invention and obvious modifications and equivalents thereof. Embodiments of the invention are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the invention. In addition, embodiments of the invention can comprise several novel features and no single feature is solely responsible for its desirable attributes or is essential to practicing the inventions herein described.

In many instances, food processing, preparation, and packaging can be a long and tedious process. For example, many issues can arise during the food packaging process. If food is improperly handled, bacteria such as e-coli can grow and become a serious health concern. To prevent an outbreak of harmful bacteria, taking precautions to safely package, transport, and store food can become very expensive, as labor, utilities, and materials costs can increase. Thus, food containers described herein can help to store and deliver food more economically, efficiently, and safely.

Traditionally, food can be packaged at a separate location other than a physical restaurant, where it will eventually be cooked and/or sold. At the separate location, the food can be packaged, and later, the food can be frozen in preparation for transport. Often, the food can be stored in food packaging such as plastic bags and flash frozen before the food is placed on a vehicle for transportation to a restaurant, for example.

When the packaged food is delivered to the restaurant, it can be stored in a freezer and/or refrigerator. In many instances, before the frozen food can be used, it needs to be heated. To heat up the frozen food, the frozen food packages can be placed in a rethermalizer. Re-thermalizing chilled or frozen foods can be expensive and take a long amount of time. Embodiments of the food container disclosed herein can advantageously be safely microwaved and/or steamed, which can be less expensive, more efficient, and take less time than heating food using traditional methods.

Once there is no need for the food packaging, the food packaging is typically discarded, thereby creating large amounts of unnecessary waste. Instead, embodiments of the food container can advantageously be used for packaging food, transporting food, heating food, and/or later holding the food in an assembly line. Accordingly, the food container described herein can help to reduce wasted materials.

In traditional assembly lines, thawed and/or heated food can be held in reusable tubs. For example, tubs containing cold food can be held in a cold water bath, while tubs containing hot food can be held in a hot water bath. Once a tub is empty or nearly empty, it can be replaced. However, before new food can be stored in the tub, the remaining contents are often removed from the tub and the tub is safely and properly cleaned. Cleaning and re-cleaning the tubs throughout the day can be very time-consuming, wasting many hours of labor. Cleaning and recycling the tubs can require a substantial amount of water, cleaning supplies, and electricity. As a result, traditional methods of storing, transporting, and heating foods can be very expensive due to the high cost of excess material, utilities such as water and electricity resulting from continuously washing tubs and re-washing tubs throughout the day, and labor necessary to clean each tub and re-fill each tub.

Advantageously, the food containers described herein can help to decrease material costs, utility costs, and labor costs. For example, the same container can be used for packaging food, transporting food, heating or chilling food, and/or later holding the food in the assembly line or a storage container, such as a warming area and/or refrigerator. In some embodiments, the food container described herein can be disposable and/or preferably recyclable. Once the food container is empty, there may be no need to wash the food container, as the food container can simply be discarded. The food container may not need additional cleaning and/or re-cleaning. As previously mentioned, this can reduce wasted water, cleaning supplies, utility costs, and/or labor costs, among others.

In some embodiments, the food container can save at least three hours per day in labor by reducing the amount of time it takes to store and prepare cold food and clean such food containers. In some embodiments, the food container can reduce labor time by at least three to five or at least six or more hours per day by, for example, reducing the amount of time it takes to store and prepare hot food and clean such food containers. Thus, the amount of labor and the associated costs of labor can be decreased. Accordingly, some embodiments of the food container can store, transport, and cook food more efficiently and cheaply than traditional methods, and decrease associated utilities and labor costs.

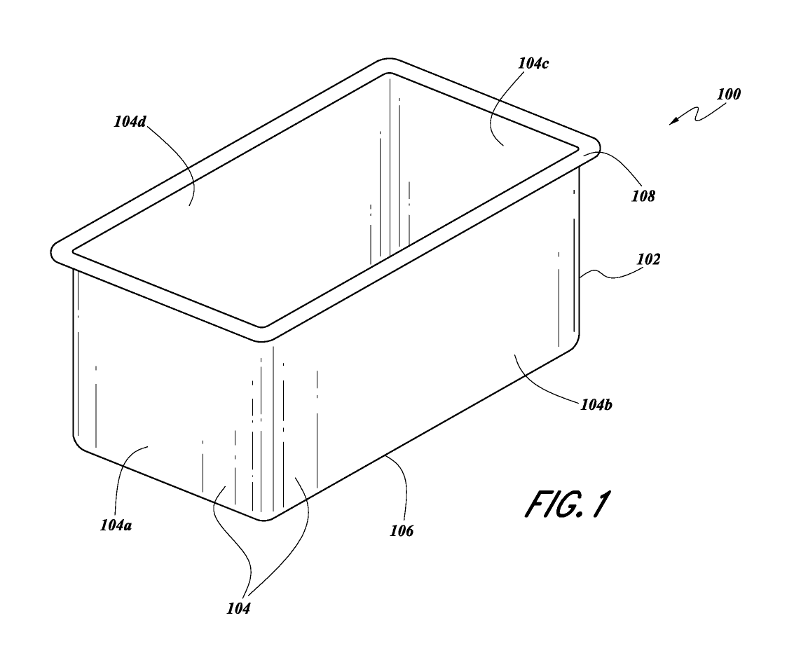

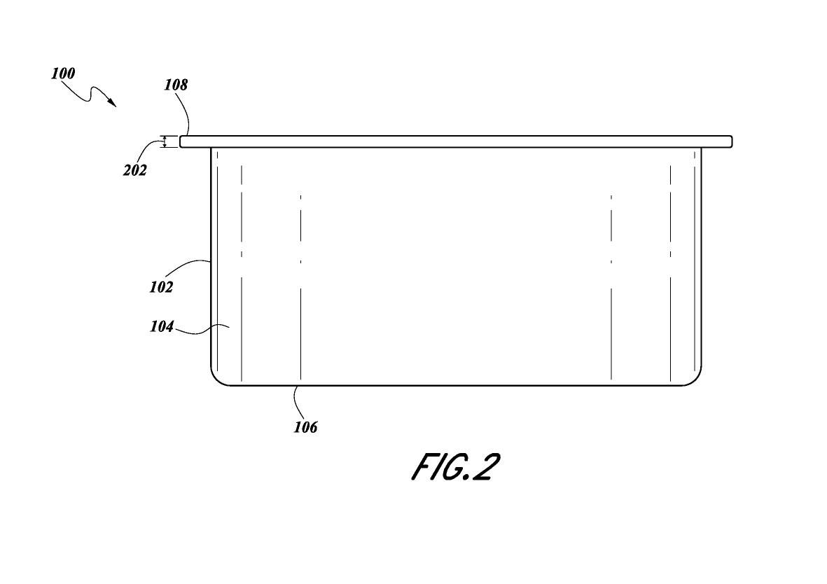

FIG. 1 is an embodiment of a food container 100. FIG. 2 illustrates a side view of the food container 100. The food container 100 includes a pan 102 defining a receptacle. In certain embodiments, the pan 102 includes one or more side walls 104, a base 106, and a lip 108. In certain embodiments, the pan 102 need not include the lip 108. In certain embodiments, a portion of the one or more sidewalls 104 forms the base 106. As described in more detail below, a top edge of the side walls 104 and/or the lip 108 can define an opening through which foods can be stored.

The pan 102 can comprise various shapes and sizes. The pan can preferably be a ⅓ size pan and/or a ⅙ size pan. For example, the pan 102 can be a standard size, such as 1/9 size pan, ⅙ size pan, ⅓ size pan, ¼ size pan, ½ size pan, and/or 1 size pan or larger. The pan 102 can be ergonomically sized to use minimal material, maximize storage space for storing food, and/or fit into various-sized microwaves.

In some embodiments, various sized pans can be used to hold a variety of types of food. For example, a larger size pan, such as the ⅓ size pan, can hold foods that may be used more often, such as lettuce, cheese, ground beef, and/or beans, among other foods. This can help to reduce the number of containers and can help to reduce waste. In some embodiments, smaller sized pans, such as the ⅙ size pan, can hold smaller and/or lesser used foods, such as onions, tomatoes, sour cream, steak, chicken, Mexican rice, and/or sauce, among other foods. As described below, the larger sized pans and/or the smaller sized pans can hold hot and/or cold foods. For example, the larger and/or the smaller sized pans can be heated and/or cooled.

As illustrated in FIG. 1, a cross-sectional shape of the pan 102 can be substantially rectangular. In some embodiments, the cross-sectional shape of the pan 102 (e.g., along a longitudinal and/or transverse axis) can be substantially cubic, oval, trapezoidal and/or circular, among other shapes.

In an embodiment, the pan 102 can have one or more side walls 104. In the illustrated embodiment, the pan 102 can have four or more side walls 104. Some configurations of the pan 102 can include one, two, three, four, five, six, seven, eight, nine, or ten or more side walls 104. In certain embodiments, corners formed at the intersections of the one or more side walls 104 can be rounded and/or form a straight edge, as illustrated in FIG. 2, for example.

Each of the one or more side walls 104 can be the same size or different sizes. For example, as illustrated in FIG. 1, a first side wall 104a and a third side wall 104c can be the same size and a second side wall 104b and a fourth side wall 104d can be the same size. Each of the one or more side walls 104 can be flat, smooth, ribbed, and/or the like. The side walls 104 can provide structural support and/or rigidity to the food container 100. In some embodiments, the side walls 104 can include various thicknesses, which can provide additional structural support. For example, at least a portion of the side walls 104 near the base 106 can have a greater thickness than a portion of the sidewalls 104 away from the base 106. The size and shape of the side walls 104 can allow the food container to be heated and/or cooled at faster or slower rates. The size and shape of the side walls 104 can allow the food container to maintain a desired temperature for longer periods of time.

The one or more side walls 104 and overall size of the pan 102 can advantageously be configured to be stacked, fit into slots in an assembly line, carried, and/or the like. In some embodiments, the one or more side walls 104 can include a handle extending outwardly from the pan 102. The handle can allow a user to easily grasp and/or carry the food container 100.

In some embodiments, the one or more side walls 104 and the base 106 forms a unitary body of the food container 100. As discussed above, the unitary body can comprise an opening formed on one end of the pan 102. The opening can be configured to receive one or more contents, such as food and/or other food containers in at least a portion of the receptacle of the pan 102.

Some embodiments of the pan 102 can include the lip 108. The lip 108 can surround the entire opening or a portion of the opening. In some embodiments, the lip 108 extends about only a portion of the opening. The lip 108 can protrude outwardly from a top portion of the one or more side walls 104. In some embodiments, the lip 108 can protrude inwardly from the top portion towards a center of the opening. In yet other embodiments, the lip 108 can protrude both inwardly and outwardly from the top portion of the one or more side walls 104. The lip 108 can be flat, curved, ribbed, and/or the like.

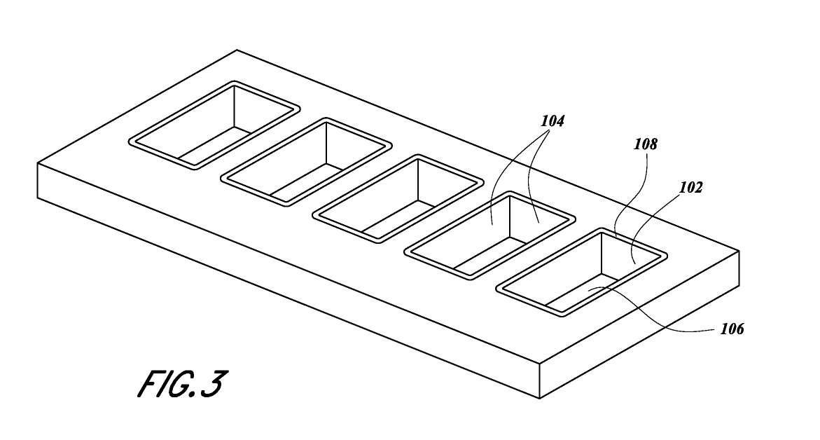

FIG. 3 illustrates an assembly line including one or more food containers 100. As illustrated in FIG. 2, the lip 108 has a thickness 202. In certain embodiments, the thickness 202 is selected to support the weight of the pan 102 and contents. For example, the thickness 202 can be selected so that only the lip 102 can support the pan 102 in the assembly line, slotted holding tray, heating table, steam table and/or cooling table, for example. In such embodiments, the pan 102 can be inserted into a slot in the assembly line. When the pan 102 is in the inserted position, a lower surface of the lip 108 can contact a top surface of the assembly line. The lip 108 can have a thickness 202 sufficient to support the pan 102. In some embodiments, the lip 108 can hold the pan 102 above hot and/or cold water among other hot and/or cold elements.

As will be described in more detail below, the lip 108 can be made of the same or different material as the pan 102. The lip 108 can include a suitable material that is strong enough for holding the food container 100 in the assembly line. The material of the lip 108 can advantageously support the pan 102 without deforming and/or yielding due to the weight of the pan 102, contents of the pan 102, and/or hot or cold temperatures applied to the food container 100 by the surrounding air, water disposed underneath the pan 102, refrigerator, freezer, microwave, steam oven, and/or combination microwave-steam oven. In certain embodiments, the one or more side walls 104 have the same thickness 202 as the lip 108. Of course the one or more sidewalls 104 need not have the same thickness as the lip 108.

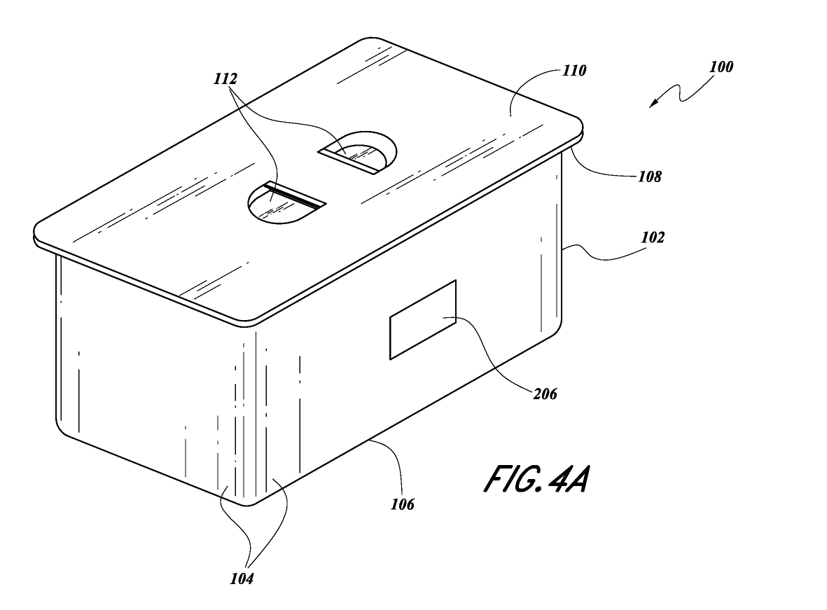

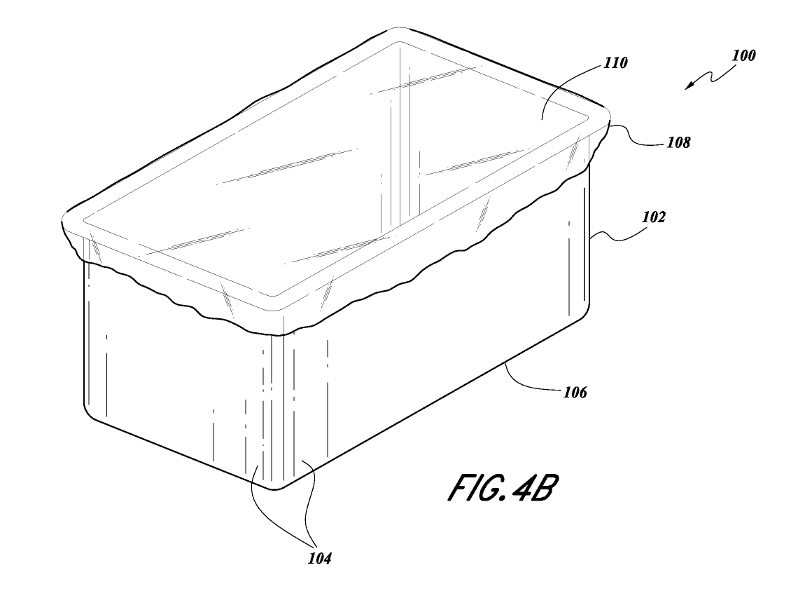

FIG. 4A illustrates an embodiment of the food container 100 that includes a lid 110 disposed over the opening into the pan 102. One or more lids 110 can be used with the pan 102. In certain embodiments, a first lid 110 initially covers the pan 102 until the first lid 110 is replaced with a second lid 110. For example, the first lid 110 can be used during transportation of the food container 100 while the second lid 110 can be used during food preparation. In some embodiments, the first lid and/or the second lid 110 is used during transportation and food preparation.

In certain embodiments, the first and second lids 110 are disposed on the pan 102 in series, one after the other. Alternatively, the first and second lids are disposed on the pan 102 at the same time in layers. For example, the first lid 110 could be removed from the second lid 110 and the pan 102 to expose the second lid 110 already disposed on the pan 102.

The first and second lids 110 could be made from the same material and/or have the same shape or be made of different materials and/or have different shapes. The material and shape of the first and second lids 110 may be selected based on the expected environment for the specific lid 110 and pan 102 combination. As explained below, these environments may include transportation, preparation, display, and storage.

In some embodiments, the lip 108 can be configured to support the first and/or second lids 110. In some embodiments, the lip 108 can be configured to support the first and/or second lids 110 and one or more food containers 100. In other embodiments, the top portion of the one or more side walls 104 can be configured to support the first and/or second lids 110. The first and/or second lids 110 can engage the pan 102 in a number of ways. For example, the first and/or second lids 110 can be configured to be slidably attached to the pan 102, to sit on top of the pan 102, to be engaged to the pan 102 by a locking mechanism, to be snapped and/or fit into the opening of the pan 102, to be snapped onto the lip 108 of the pan 102, to be snapped onto the top portion of the one or more side walls 104, and/or the like.

In some embodiments, the first and/or second lids 110 can comprise a handle 112. The handle 112 can extend away from a surface of the first and/or second lids 110. In certain embodiments, the handle 112 is recessed within the first and/or second lids 110. For example, the handle 112 can extend downwardly into the first and/or second lids 110 and form one or more depressions.

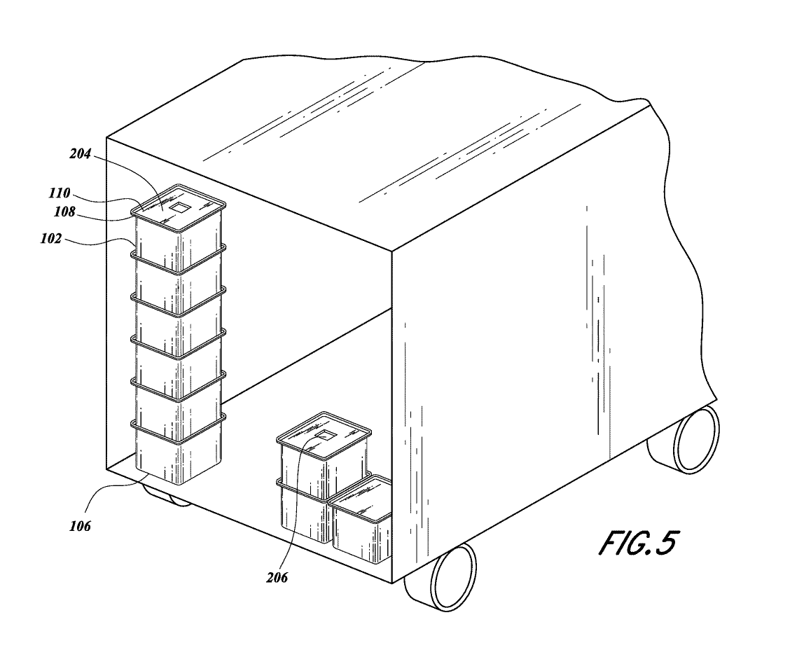

In some embodiments, the first and/or second lids 110 can include a recess 204 as is illustrated in FIG. 5. The recess 204 can be substantially oval-shaped, circular, rectangular, and/or among other shapes. In some embodiments, the recess 204 of the first and/or second lids 110 can be shaped to receive the base 106 of an adjacent pan 102.

FIG. 5 illustrates a plurality of food containers 100 stacked inside the storage area of a transport vehicle. In some embodiments, the food container 100 includes an engagement feature. The engagement feature can include the first and/or second lids 110. The engagement feature can help to limit lateral movement of a second food container 100 disposed above a first food container 100. As illustrated in FIG. 5, the first and/or second lids 110 of a first food container can receive the base 106 of a second food container. In this arrangement, a plurality of food containers 100 can be stored easily on a truck, at a storage facility, at a packaging plant, and/or at a restaurant, for example. Stacking the plurality of food containers 100 can allow the food containers 100 to take up less space. In certain embodiments, densely packed food containers 100 reduce temperature fluctuations of their contents as compared to a more distributed arrangement of food containers 100 during transport.

The base 106 of the second food container can engage the first and/or second lids 110 of the first food container in several ways. For example, the base can sit in the recess 204 formed in the first and/or second lids 110. In this embodiment, each food container can be locked into place by the weight of the plurality of food containers sitting on top of the food containers. In some embodiments, the plurality of food containers 100 are locked into place by the engagement feature, such as a snap fit, clip, clamp, and/or handle, among other locking mechanisms.

As will be described in more detail below, the first and/or second lids 110 can be made of the same or different material as the pan 102 and/or the lip 108. The first and/or second lids 110 can made of a suitable material that is strong enough for supporting a plurality of food containers stacked on top of the first and/or second lids 110. The material of the first and/or second lids 110 can advantageously support the plurality of food containers stacked on top of the first and/or second lids 110 without plastically deforming and/or yielding due to the weight of the plurality of food containers, and/or temperature of the surrounding food containers.

As illustrated in FIG. 4B, the food container 100 can include a first lid 110. The first lid 110 can be used during transportation of the food containers 110. The first lid 110 can include a plastic wrap. The plastic wrap can be a single use plastic wrap and/or be implemented for temporary use. In some embodiments, the plastic wrap can be wrapped around the plurality of food containers 100 to hold the food containers in place during transportation. In some embodiments, the plastic wrap can be wrapped around an individual food container of the plurality of food containers to temporarily hold in contents of the food container 110. In such configurations, the plastic wrap can be wrapped around only a portion of the food container. For example, the plastic wrap can be attached to the food container at a top surface of the lip 108, a bottom surface of the lip 108, the side walls 104, and/or the base 106.

In some embodiments, the food container 100 can include the second lid 110. The second lid 110 can be used during storage and preparation of food contents within the food container 100. For example, the second lid 110 can advantageously cover the pan 102 before, during, and/or after the food container 100 is microwaved, steamed, frozen, and/or otherwise cooled and/or heated. In some embodiments, the second lid 110 can be made of any material described herein.

In some examples, a single lid 110 can be used for any environment. The lid 110 can include many of the same features of the first and/or second lid 110 described herein. For example, the lid 110 can be made of a multi-use plastic. In some embodiments, the lid 110 can be used during transportation, storage, and/or preparation of food contents in the food container 100. Similar to other configurations described herein, the lid 110 can advantageously cover the pan 102 before, during, and/or after the food container 100 is microwaved, steamed, frozen, and/or otherwise cooled and/or heated.

As illustrated in FIGS. 3 and 5, the food container 100 can be used in a plurality of locations and in numerous ways. For example, as described above, the food container 100 can be used to package food at a packaging facility. The food container 100 can be loaded onto a truck, as illustrated in FIG. 5 for transportation to individual restaurants at remote locations. Once the food containers 100 are delivered to and/or stored at the restaurants, the food containers 100 can be stored in a refrigerator, freezer and/or other storage area. In some embodiments, the food containers 100 can be microwaved or otherwise heated. For example, the food container 100 can be heated at about 275° F. In some embodiments, the food container 100 can be heated at about 200° F. to 225° F., about 225° F. to 250° F., about 250° F. to 275° F., about 275° F. to 300° F., about 300° F. to 375° F., and/or warmer. In other embodiments, the food containers 100 can be refrigerated, cooled, and/or frozen. For example, the food container 100 can be cooled at about 34° F. In some embodiments, the food container 100 is heated to about 30° F. to 32° F., about 32° F. to 34° F. about 34° F. to 40° F. about 40° F. to 50° F., or warmer. In use, the food container 100 can be placed in an assembly line. In some embodiments, the food containers 100 can be held in place in the assembly line over cooled and/or heated water.

As described above, the pan 102 can be disposable, recyclable, and/or reusable. In some embodiments, the pan 102 can advantageously be microwavable, freezable, or otherwise cooled and/or heated. Accordingly, the pan 102 and/or other components described herein can be made of one or more materials, such as plastic, plastic film, polypropylene, polystyrene, polycarbonate fiber, glass, rubber, and/or paper, among others. At least a portion of the pan 102 can preferably include polypropylene, for example. In some embodiments, the side walls 104 includes polypropylene. In some embodiments, the material of the food container 100 can comprise properties that reduce leaching of toxins into the food when the food container 100 is microwaved.

The one or more materials can be stain-resistant and/or crack resistant. Some example materials described herein can be rigid, while others can be flexible. The one or more materials can increase the durability and/or portability of the pan 102. The one or more materials can decrease the size and/or weight of the pan 102. The same one or more materials can be used for each element of the food container 100. In some embodiments, an inner layer of the pan 102 comprises a different material than an outer layer of the pan 102. In some embodiments, the lid 110 can comprise the same material as the pan 102. In other embodiments, the lid 110 comprises a different material from the pan 102. In some embodiments, the lip 108 can comprise the same and/or different material from the pan 102 and/or lid 110. In some embodiments, the side walls 104 of the pan 102 can include the same or different material from the remainder of the pan 102. The materials described herein can allow the food container to be heated and/or cooled. The materials described herein can be safely implemented without substantial plastic yielding and/or deformation. In certain embodiments, the material can help to limit the food container 100 from catching fire and/or causing a fire when heated.

In some embodiments, the food container 100 can contain a label 206. The label 206 can comply with FDA requirements. As illustrated in FIGS. 4 and 5, the label can be attached and/or imprinted on an outside surface of the food container 100. In some embodiments, the label 206 can be attached to the one or more side walls 104. In some embodiments, the label 206 can be attached to the lid 110. In some embodiments, the label 206 can be affixed to a wrapping that surrounds one or more food containers 100. In some embodiments, the label 206 can be removable. In other embodiments, the label 206 can be permanently affixed or permanently stamped onto the food container.

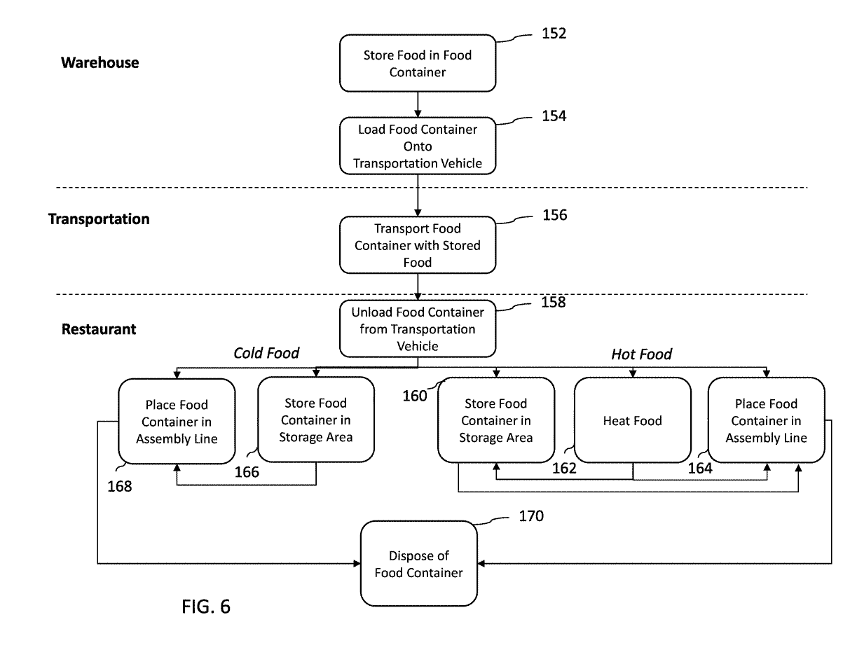

FIG. 6 illustrates an example method of using the food container 100 described herein. As previously discussed, the food container 100 can be packaged at a first location, such as a warehouse and/or packaging facility, and transported to a second location, such as a restaurant. For example, at block 152, at least one food can be packaged into the food container 100 at the first location. At the first location, the food container 100, which includes the food, can be loaded onto a transportation vehicle, at block 154.

As previously discussed, FIG. 5 illustrates an embodiment of the food container 100 loaded onto a transportation vehicle for transportation to a second location, such as individual restaurants. At block 156, the food container 100 is transported from the first location to the second location. At block 158, the food container 100 can be unloaded from the transportation vehicle at the second location.

In some embodiments, cold foods and hot foods are unloaded in the same manner and/or stored in the same area. In some embodiments, cold foods and hot foods are unloaded using a different method and/or stored in a different location. For example, once the food container 100 is unloaded from the transportation vehicle, the food container 100 can be stored directly in a storage area. Cold foods described herein can include foods that are cooled and/or kept at room temperature.

If the food stored within the food container 100 is a hot food, the food container 100 can be stored in a storage area at block 160. The storage area can be temperature controlled (e.g., cooled, heated, and/or maintained). In some embodiments, the storage area for hot foods may be a heated room or cabinet, such as a warming tray, for example, that can maintain the temperature of the contents of the food container. In some embodiments, the storage area includes a cooled area. At block 164, the food container can be moved from the storage area and directly placed into an assembly line (for example, as shown in FIG. 3). Thus, the food container 100 can help to reduce the amount of labor by limiting the need to fill and/or re-fill the food container at the restaurant, for example, and/or clean the food container between uses.

At block 162, the food container 100 can be heated. For example, the food container 100 can be moved directly from the transportation vehicle and placed into a food warmer, such as a microwave, rethermalizer, and/or oven. In some embodiments, the food container 100 is first stored in a storage area at block 160 and later heated according to the methods described herein.

Once the foods stored in the food container 100 are heated to the desired temperature and/or for the desired length of time, the food container 100 can be stored in a storage area that maintains the temperature of the food container 100 and/or warms the food container 100. In some embodiments, once the food container 100 is appropriately heated, the food container 100 is placed directly into the assembly line at block 164.

At block 164, the food container can be moved directly from the transportation vehicle and placed into the assembly line, from the storage area into the assembly line, and/or from the heating area (e.g., a microwave, rethermalizer, and/or oven) into the assembly line. Such embodiments can help to reduce costs, as described above. For example, the same food container could be unloaded from the transportation vehicle, stored in a storage area, and/or placed directly into the assembly line. This can help to reduce labor and/or waste, among others.

In some embodiments, the food container is disposable. For example, the food container 100 may be discarded after a single use. As shown in FIG. 6, once the food container 100 is placed in the assembly line, the food container can be discarded or disposed of at block 170. This can help to reduce labor, as discussed above, by reducing the need to clean and/or re-clean food containers.

As mentioned above, once the food container 100 is unloaded from the transportation vehicle, the food container 100 can be stored directly in the storage area. If the food disposed within the food container 100 is a cold food, the food container 100 can be stored in a storage area at block 166. The storage area at block 166 can be the same or different from the storage area at block 160. The storage areas at blocks 160, 166 can include multiple storage areas that have the same or different temperatures. The storage area at block 166 can be temperature controlled (e.g., cooled, heated, and/or maintained). In some embodiments, the storage area for cold foods may be a cooled room or cabinet, such as a refrigerator, for example, that can maintain the temperature or decrease the temperature of the contents of the food container 100. In some embodiments, the storage area includes a cooled area to limit spoiled foods. At block 168, the food container can be placed from the storage area directly into an assembly line (for example, as shown in FIG. 3). The assembly line at block 168 can be the same or different from the assembly line at block 164.

At block 168, the food container 100 can be placed directly into the assembly line from the transportation vehicle. Once the food container 100 is placed in the assembly line, the food container can be discarded or disposed of at block 170.

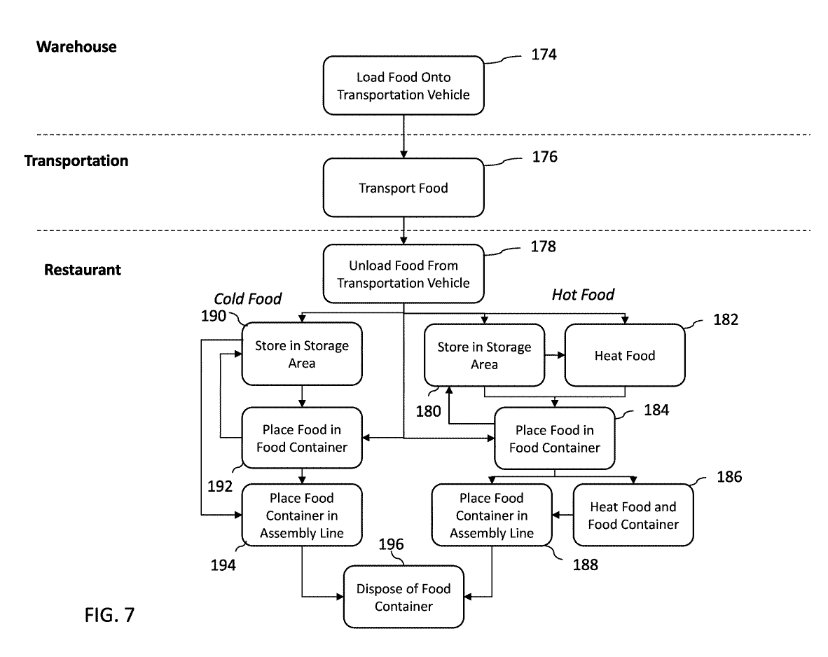

FIG. 7 illustrates an example method of using the food container 100 described herein. The method shown in FIG. 7 can include the same or identical features of the method shown in FIG. 6. At block 174, foods can be packed and loaded onto a transportation vehicle at a first location, such as a warehouse and/or packaging facility. At block 176, the foods can be transported from the first location to a second location, such as a restaurant. At block 178, the foods can be unloaded from the transportation vehicle at the second location.

If the food is a hot food, the food container 100 can be stored in a storage area at block 180 and/or directly heated at block 182 using methods described above. The storage area can be temperature controlled (e.g., cooled, heated, and/or maintained). In some embodiments, the storage area for hot foods may be a heated room or cabinet, such as a warming tray, for example, that can maintain the temperature of the foods. In some embodiments, the storage area includes a cooled area.

At block 182, the food can be heated, as discussed above. Alternatively, the food can be placed in the food container 100 at block 184. At block 184, the foods can be placed in the food container 100 and/or stored in the storage area at block 180. Once the food is placed in the food container 100, the food and food container can be stored in the storage area at block 180, heated or warmed at block 186, and/or placed directly into an assembly line at block 188. As discussed above, the food container 100 can desirably be heated with the foods disposed within the food container 100. Once the food container 100, including the food, is heated, the food container can be placed within an assembly line at block 188, as described herein. As shown in FIG. 7, once the food container 100 is placed in the assembly line, the food container can be discarded or disposed of at block 196.

As mentioned above, once the food is unloaded from the transportation vehicle, the food container 100 can be stored directly in the storage area. If the food is a cold food, the food container 100 can be stored in a storage area at block 190. The storage area at block 190 can be the same or different from the storage area at block 180. The storage areas at blocks 180, 190 can include multiple storage areas that are at the same or different temperatures. The storage area at block 190 can be temperature controlled (e.g., cooled, heated, and/or maintained). In some embodiments, the storage area for cold food may be a cooled room or cabinet, such as a refrigerator, for example, that can maintain the temperature or decrease the temperature of the food. In some embodiments, the storage area includes a cooled area.

At block 192, the food can be transferred from the storage area into the food container 100. In some embodiments, the food can be transferred directly from the transportation vehicle at block 178 to the food container 100, at block 192.

Once the food is placed into the food container 100, the food container can be placed directly into an assembly line at block 194 and/or into the storage area at block 190. In some embodiments, for example at block 194, the food can be placed directly into the food container 100 already positioned in an assembly line (for example, as shown in FIG. 3). The assembly line at block 194 can be the same or different from the assembly line at block 188.

As shown in FIG. 7, once the food container 100 is placed in the assembly line, the food container can subsequently be discarded or disposed of at block 196.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. The headings used herein are for the convenience of the reader only and are not meant to limit the scope of the inventions or claims.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Additionally, the skilled artisan will recognize that any of the above-described methods can be carried out using any appropriate apparatus. Further, the disclosure herein of any particular feature, aspect, method, property, characteristic, quality, attribute, element, or the like in connection with an embodiment can be used in all other embodiments set forth herein. For all of the embodiments described herein the steps of the methods need not be performed sequentially. Thus, it is intended that the scope of the present invention herein disclosed should not be limited by the particular disclosed embodiments described above.

What is claimed is:

1. A disposable food container comprising:
a pan being sized and shaped to define a receptacle for holding food, at least a portion of the pan comprising polypropylene.

2. The disposable food container of claim 1, wherein the pan further comprises a plurality of side walls and a lip extending outwardly from a top end of the plurality of side walls, and wherein the lip is sized and shaped to support the pan.

3. The disposable food container of claim 1, wherein the food container is configured to be heated at a heating temperature of at least 275 degrees Fahrenheit, and wherein the melting temperature of the polypropylene is greater than the heating temperature.

4. The disposable food container of claim 1, wherein the food container is configured to be heated at a heating temperature of at least 275 degrees Fahrenheit, and wherein the deformation temperature of the polypropylene is greater than the heating temperature.

5. The disposable food container of claim 1, wherein the food container further comprises an engagement feature, and wherein the engagement feature limits lateral movement of a second food container disposed above the food container.

6. The disposable food container of claim 5, wherein the engagement feature includes a lid, and wherein the lid includes a recess configured to receive at least a portion of the second food container.

7. The disposable food container of claim 1, wherein the food container is configured to be cooled at a cooling temperature of at least 34 degrees Fahrenheit, and wherein the freezing temperature of the polypropylene is less than the cooling temperature.

8. The disposable food container of claim 2, wherein the plurality of sidewalls are configured to not substantially deform when a temperature of the food container is adjusted.

9. A method of implementing a disposable food container, the method comprising:
storing a food in a disposable food container, the food container including a pan sized and shaped to define a receptacle for holding the food, at least a portion of the pan comprising polypropylene;
heating the pan with the food disposed within the receptacle; and
locating the pan into a slot of an assembly line.

10. The method of claim 9, wherein the pan further comprises a plurality of side walls and a lip extending outwardly from a top end of the plurality of side walls, and wherein the lip is sized and shaped to support the pan.

11. The method of claim 10, wherein a bottom surface of the lip of the pan is configured to contact an upper surface of an assembly line, and wherein the lip is sized and shaped to support the pan within the slot of the assembly line.

12. The method of claim 9, wherein the heating the pan comprises heating the pan at a heating temperature of at least 275 degrees Fahrenheit, and wherein the melting temperature of the polypropylene is greater than the heating temperature.

13. The method of claim 9, wherein the heating the pan comprises heating the pan at a heating temperature of at least 275 degrees Fahrenheit, and wherein the deformation temperature of the polypropylene is greater than the heating temperature.

14. The method of claim 9, wherein the food container does not substantially deform when the food container is heated.

15. The method of claim 9, further comprising stacking the food container above a second food container, wherein the plurality of side walls is configured to support the second food container disposed above the pan.

16. The method of claim 15, wherein the food container further comprises an engagement feature, and wherein the engagement feature limits lateral movement of the second food container disposed above the food container.

17. A method of storing food, the method comprising:
storing food in a stackable food container at a first location, the food container including a pan sized and shaped to define a receptacle for holding the food, at least a portion of the pan comprising polypropylene; and
stacking the food container on top of a second food container.

18. The method of claim 17, wherein the pan further comprises a plurality of side walls and a lip extending outwardly from a top end of the plurality of side walls, and wherein the lip is sized and shaped to support the pan.

19. The method of claim 18, wherein a bottom surface of the lip of the pan is configured to contact an upper surface of an assembly line, and wherein the lip is sized and shaped to support the pan within the slot of the assembly line.

20. The method of claim 17, wherein the food container is configured to be heated at a heating temperature of at least 275 degrees Fahrenheit, and wherein the melting temperature of the polypropylene is greater than the heating temperature.
